(19) United States
(12) Patent Application Publication
(10) Pub. No.: US 2010/0277326 A1
(43) Pub. Date: Nov. 4, 2010

(54) METHOD AND SYSTEM FOR MONITORING PORTABLE COMMUNICATION DEVICES

(75) Inventors: Mitchell Berk, Washington, DC (US); Ashwath Akirekadu, Laurel, MD (US)

Correspondence Address: PEPPER HAMILTON LLP, ONE MELLON CENTER, 50TH FLOOR, 500 GRANT STREET, PITTSBURGH, PA, 15219, US

(73) Assignee: BoxTone, Inc., Columbia, MD (US)

(21) Appl. No.: 12/434,090

(22) Filed: May 1, 2009

(51) Int. Cl. G08B 21/00; H04M 1/00

(52) U.S. Cl. 340/636.11; 455/550.1

(57) ABSTRACT

A method of supporting portable digital devices includes providing each device with an installed service application. The service application for each device monitors operational parameters associated with other applications that are running on the device. When a monitored parameter suggests a device operational problem, the service application generates an alert, and it provides the device's user with information about how to resolve the alert. The application also may transmit the alert, along with data showing the applications running and the monitored parameters at the time of the alert, to a remote service operation. Also, during non-alert conditions, the application may periodically transmit data showing the applications running and the monitored parameters at the time of the transmission. The service operation may use this data to identify trends, manage device operation, or perform other functions.

### BACKGROUND

Portable electronic communication devices, such as mobile phones, personal digital assistants, and hand-held computing devices, have become critical to the lives of many individuals and professionals. Many professional users need to use portable communications devices at any time, and any place, in order to conduct business. However, when a device cannot operate in the manner that the user operates, the user may be frustrated and unable to conduct business. Such problems can include a low battery level, a lack of sufficient processor or memory capacity, software and/or hardware configuration issues, or an external communications network that is providing a weak signal—or even no signal at all. Typically, such problems occur with little or no warning, and users only learn of an issue when it occurs. In addition, system administrators—such as information technology personnel who oversee a group of portable communication devices and their users—must spend a significant amount of time resolving problems, often after it is too late to gather information that could have been used to resolve the problem or evaluate how to avoid the problem in the future.

The inventors have discovered a method and system that alerts communication device users of potential problems before they occur, and which provides users, and optionally system administrators, the ability to avoid, delay the occurrence of, or resolve the problem. The disclosure contained herein describes various embodiments of a method and system for resolving one or more of the problems described above.

### SUMMARY

In an embodiment, a computer program product for monitoring the performance of a portable communications device includes a computer-readable medium. The medium contains instructions that cause a portable communications device to monitor: (i) at least one system configuration parameter associated with the device; (ii) at least one usage parameter associated with an operating system within the device; and (iii) at least one operating parameter associated with a communications network that the device is using for communication. When any of the monitored parameters has a value indicative of a potential operational problem on the device, the instructions cause the device to generate an alert that may be displayed, and provide a user-selectable prompt that enables a user to receive resolution information on how to avoid the potential problem. The instructions may cause the device to display the resolution information. The instructions also may provide a user-selectable prompt that enables the user to implement a command on the device, such that the command is associated with the resolution information.

In the embodiment described above, the instructions also may cause the device to monitor at least one parameter associated with an installed messaging application on the device. The instructions also cause the device to monitor at least one operating parameter associated with a messaging application that is installed in the device, wherein the potential operational problem is an indication that the device is holding messages that take up more than a threshold amount of memory.

Optionally, the monitored operating parameter associated with the memory may be an indicator of an amount of available free memory, the potential operational problem may be a low available free memory, and the command may include closing an application that is using the memory to run.

Optionally, the instructions also may cause the device to monitor a battery drain rate for the device. If the monitored battery drain rate exceeds a threshold, the instructions may cause the device to display a battery drain alert, identify an application is running on the device and which requires a battery drain rate that exceeds that of at least one other application that is also running on the device, and provide a user-selectable prompt that enables the user to close the identified application. Alternatively, if the monitored battery drain rate exceeds a threshold, the instructions may cause the device to automatically implement an action on the device that will reduce the battery drain rate.

The instructions also may cause the device to provide the user with a screen capture option. The screen capture option may enable a user to record a snapshot of a display screen on the device, where the display screen may display the monitored parameters at the time of the snapshot. The option may save a snapshot file comprising data corresponding to the snapshot and transmit the snapshot file to a remote support operation via the communications network.

The instructions also may cause the device to automatically transmit some or all of the alerts to a remote support operation. For each transmitted alert, the device may automatically transmit the monitored parameters at the time of the alert and an indication of applications that were in use on the device at the time that the alert was generated.

The instructions also may periodically cause the device to transmit to the remote support operation, during non-alert periods, an indication of applications that are in use on the device at the time. They also may periodically cause the device to transmit to the remote support operation, during non-alert periods, the monitored parameters for the applications that are in use. In response to a request from the remote support operation, the device may transmit an indication of applications that are in use on the device at the time, as well as the monitored parameters for the applications that are in use.

The device also may store the alerts and monitored parameters over a period of time, and after the period of time, the device may correlate the alerts and monitored parameters to generate a report of at least one operational trend for the device over the period of time. If the trend indicates that memory usage has increased by a threshold amount over the period of time, the resolution information may include a suggestion to add additional memory to the device.

The instructions also may cause the device to determine, from the stored alerts and monitored parameters, an expected operational condition over a period of time. The instructions also may cause the device to analyze the stored alerts and monitored parameters to determine whether the device is operating outside of an accepted deviation range from the expected operational condition. The expected operational condition may include an expected amount of time that a communication application is typically in use when a device is roaming outside of a standard network area. The analyzing may include determining whether the device is using a roaming service at a level that exceeds the expected amount of time by a threshold amount. The expected operational condition comprises an expected amount of time that a communication application encounters a loss of communications network coverage. The analyzing may include determining whether the device has encountered a loss of communications network coverage at a level that exceeds the expected amount of time by a threshold amount, and if so identifying a communications network service provider for the communicating network and automatically transmitting an indication of the provider to a remote support operation.

### BRIEF DESCRIPTION OF THE DRAWINGS

FIG. 1 is a block diagram that depicts an exemplary portable communications device.

FIG. 2 depicts an exemplary portable communications device and various applications that may be installed on the device.

FIGS. 3 and 4 are process flow diagrams of exemplary elements of a portable digital de vice monitoring method.

FIG. 5 illustrates an exemplary report of various monitored trends over time.

FIG. 6 illustrates an exemplary report of alert times and types.

FIG. 7 illustrates an exemplary displayed report of monitored parameters.

FIG. 8 illustrates exemplary hardware components of a portable communications device.

### DETAILED DESCRIPTION

Before the present methods and systems are described, it is to be understood that this disclosure is not limited to the particular methodologies and systems described, as these may vary. The terminology used in the description is only for the purpose of describing the particular versions or embodiments, and it is not intended to limit the scope. For example, as used herein and in the appended claims, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

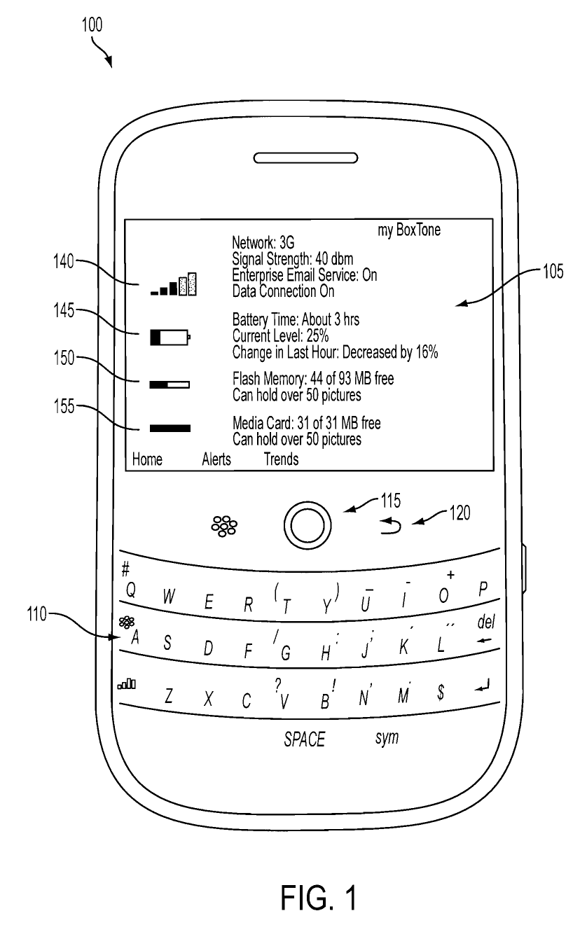

In an embodiment, an application may be installed on a portable electronic communications device. As used in this document, and as illustrated in FIG. 1, a portable communications device 100 is any electronic device that includes a processor and a storage memory such as a hard drive, media card, flash memory or the like for storing application instructions, data files and the like. The device 100 also includes an operational memory such as random access memory that is used to contain operating instructions for applications that are in use on the device at any point in time. The device 100 also includes a display 105 and an input mechanism such as a keyboard 110, trackball 115, track wheel, touch-sensitive wheel, user-selectable buttons 120, or a touch-sensitive screen (which also may serve as the display). The device also includes a wireless communications port that enables the device to send and receive messages via an external communications network, such as a mobile phone service. The device also includes a battery that powers the device when the device is not electronically connected to an external power source. An application is a computer program product that may be stored in a memory such as the device's storage memory, and which may be run using the processor and an operational memory of the device.

In an embodiment, a monitoring application is installed on a communications device and monitors usage parameters that assess system configuration, key performance indicators, and performance of other applications running on the device, as well as usage parameters for various components of the device's hardware. FIG. 1 illustrates, by icons on the display 105, exemplary hardware components that may be monitored such as a communications port 140, which may be monitored for usage parameters such as signal strength and/or whether the network is supplying a standard service or non-standard service such as roaming. The device's battery 145 or other power supply may be monitored for usage parameters such as status details such as remaining battery level, and drain or usage rate. The application also may monitor one or more memory devices 150, 155 such as a flash memory, media card, hard drive and/or random access memory usage parameters such as space used and/or available free memory.

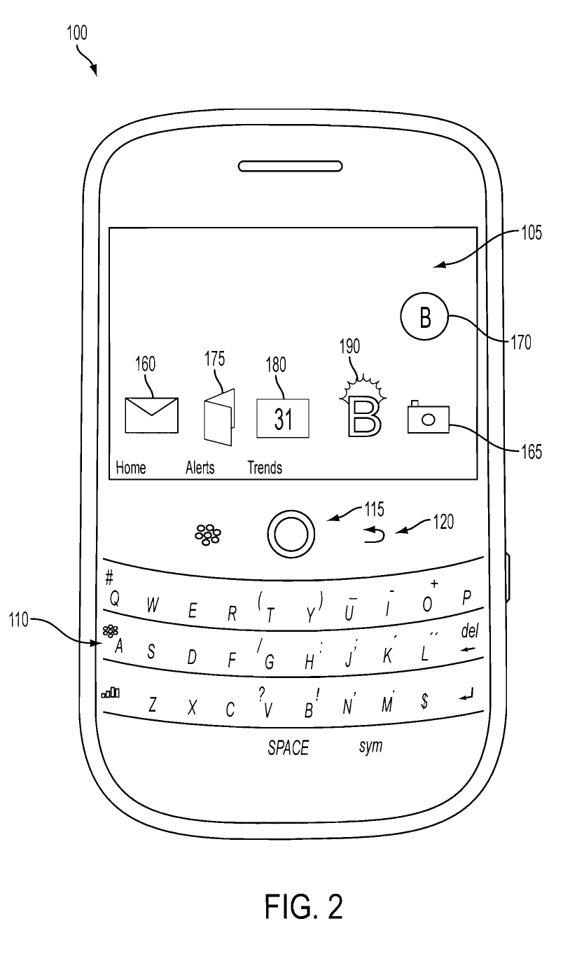

Other applications and configuration parameters that may be monitored are represented by icons in the display of FIG. 2. A messaging application 160 may include an electronic mail, text message, voice communication, mobile business application (such as a customer relationship management application) or other communications program. The messaging application 160 allows the user of the device to communicate with other devices and or a remote server via a communications network. A camera application 165 may enable the device to capture photographs, videos, or audio messages. A browser 170 may enable the device to access text and images via the communications network, such as via the Internet. Other applications may include programs such as an address book 175, calendar 180, media player, game, or other applications.

A service application 190 may identify system configuration parameters, such as memory cache settings, times during which an antenna will power on or off, volume controls, screen brightness settings, and related system parameters. In addition or alternatively, the service application 190 may include a notifier, such as an icon that changes its color, size, or base image, a pop-up, a tone, a vibration mechanism, an on-screen indicator, or another audible, tactile, or visual notification device. The notifier may activate when the service application determines that a user should be alerted of an actual or potential issue associated with the hardware or other applications.

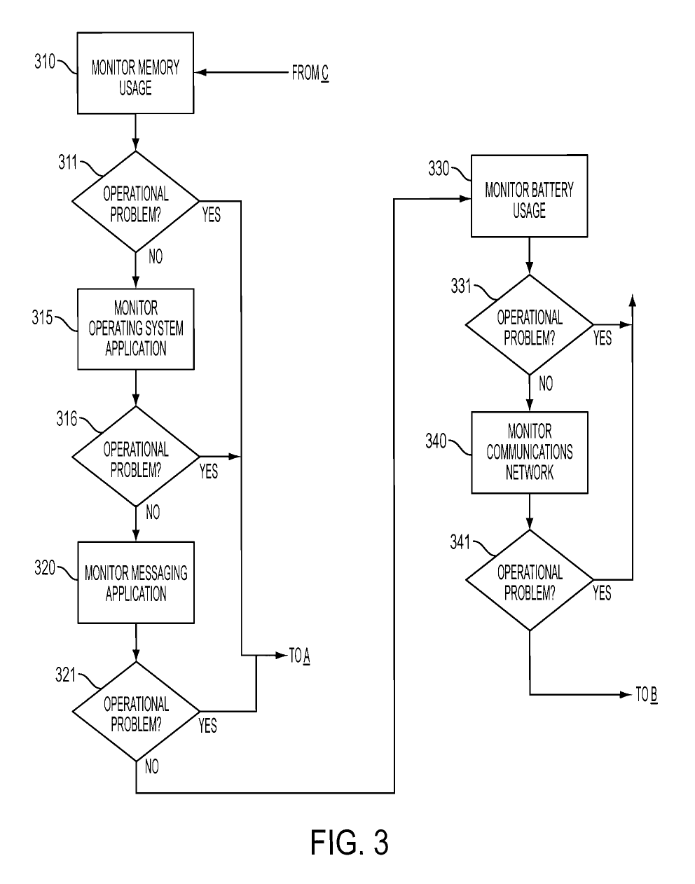

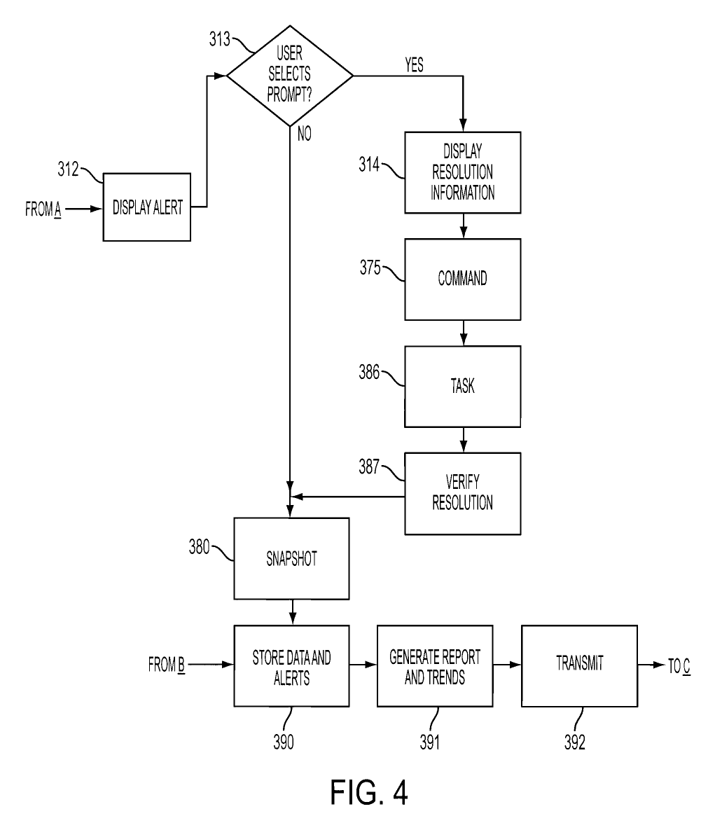

The service application 190 may contain computer program instructions that cause the processor of the communications device to monitor parameters of the device operating system applications and hardware, track the parameters and identify trends, and issue alerts when appropriate. FIGS. 3 and 4 illustrate exemplary tasks that instructions of the usage application may cause the device to implement. For example, the service application may monitor an operating system parameter such as 310 memory usage. The service application may compare the parameter against one or more rules, thresholds and/or baselines to determine whether an operational problem 311 exists. For example, this may include monitoring the available free memory in a device memory, and if the available free memory has a value indicative of a potential operational problem 311, displaying an alert 312. The alert may be displayed on a display screen of the device, recorded locally or remotely, or it may be transmitted to a remote support operation for display on a display of a remote system, such as a network carrier or system administrator. Alerts may include data such as out of network coverage, low memory, low battery, battery too low for antenna, antenna disabled, data services disabled, rapid battery drain, media card full, data connection refused on roaming network, SIM card missing or faulty, roaming, or a configuration error. The alert may provide the user with a user-selectable prompt that enables the user to select the prompt 313 and receive resolution information 314 on how to avoid the potential problem. In response to the prompt, the user may launch a command 375 or task 386 that is associated with the resolution information and which helps avoid the problem. Optionally, the system may verify resolution 387 by monitoring the parameters again or requesting user input.

For example, if available random access memory is below a threshold amount, such as below 10% of capacity, the device may display an alert icon (see., e.g., icon 190 in FIG. 2), and the user may receive resolution information that suggests that the user close one or more applications that are running on the device. The resolution information may include a link or button or other input mechanism that enables the user to launch the command directly from the service application. The service application may suggest one or more applications to close based on those using the most memory, those which the user has not directly accessed as recently as other applications, or based on other factors. Similarly, the service application may monitor memory in a hard drive, a flash memory, a media card, or another memory device. If available free memory in any of the monitored memory devices is below a threshold amount, the device may display an alert, and the user may be prompted to resolve the issue issuing a command that closes (or to not use) memory-intensive applications such as video or camera applications, or by adding additional memory such as through an expansion memory card.

The service application may also monitor one or more parameters associated with a system configuration parameter 315 or a messaging application 320. A messaging application is an application that manages the creation, sending and receipt of messages, such as an e-mail application or a mobile business application. The parameters associated with a messaging application may include, whether an available or required update is due for the application, whether the messaging application is holding messages that take up more than a threshold amount of memory or available free memory, whether the messaging application shares data with another installed application, or the like. The parameters associated with system configuration may include, for example, memory cache settings, times during which an antenna will power on or off, volume controls, and screen brightness. The service application may compare the parameters against one or more rules, thresholds and/or baselines to determine whether an operational problem 321 exists. For example, if any of the parameters has a value indicative of a potential operational problem 321, the application will display an alert 312 on a display of the device or of a remote support operation. The alert may provide the user with a user-selectable prompt that enables the user to select the prompt 313 and receive resolution information 314 on how to avoid the potential problem. In response to the prompt, the user may launch a command 375 or task 386 that is associated with the resolution information and which helps avoid the problem.

The service application may also monitor one or more parameters associated with battery usage 330. The parameters may include, for example, a remaining battery life, or a rate of drain of the battery over a period of time. The service application may compare the parameters against one or more rules, thresholds and/or baselines to determine whether an operational problem 321 exists. For example, if a parameter has a value indicative of a potential operational problem 331 such as a battery level that is below a threshold or a battery drain rate that exceeds a threshold, the application may display an alert 312 on the device. The alert may provide the user with a user-selectable prompt that enables the user to select the prompt 313 and receive resolution information 314 on how to avoid the potential problem. In response to the prompt, the user may launch a command 375 or task 386 that is associated with the resolution information and which helps avoid the problem. Optionally, the service application may automatically launch the command or task to avoid the problem, such as by reducing screen brightness, turning off a speaker, or taking another action that will reduce battery usage.

Optionally, the alert may include a change in status of an icon associated with the service application. The change in status may differ based on the severity of the alert levels. For example, if the service application detects that a user has taken too many photos and thus caused memory to be low, the icon may change to the color yellow. The user may then be prompted to purge files to restore available space. For a more serious issue, such as a network failure that disrupts email capability, the icon may change to a red color. In either case, when the icon alerts the user to a problem, the user may open the application to see more detail about the issues, along with instructions for proposed resolutions of the issue.

The service application may also monitor one or more parameters associated with the wireless communications network to which the device is connected 340. The parameters may include, for example, a signal strength, a number of dropped calls or message transmissions, an identification of the network service provider, and an indication of whether the network is providing a standard service or premium service such as roaming. The service application may compare the parameter against one or more rules, thresholds and/or baselines to determine whether an operational problem 341 exists. For example, if a parameter has a value indicative of a potential operational problem 341 such as a number of dropped calls that exceeds a threshold during a time period, the application will display an alert 312 on the device. The alert may provide the user with a user-selectable prompt that enables the user to select the prompt 313 and receive resolution information 314 on how to avoid the potential problem. In response to the prompt, the user may launch a command 375 or task 386 that is associated with the resolution information and which helps avoid the problem. For example, the user may be prompted to transmit 392 the monitored parameters to a remote support operation so that the remote support operation can collectively evaluate the performance of the network service provider for this device and other devices that the support operation handles.

The device may store 390 any of the monitored data, alerts, commands and/or tasks in a memory of the device. The storing may be done automatically, or in response to a user-submitted command. Such a command may include a snapshot command 380 that saves a snapshot of displayed operating parameters and/or alerts at the time of a problem. The snapshot may be a file containing a screenshot, a sequence of screenshots, or a video of displayed information. Optionally, the snapshot may include a capture of the display of another running application. The snapshot may be immediate, or the user may be permitted to select a time delay so that the snapshot is taken at a future point in time, such as after an application has run for a period of time.

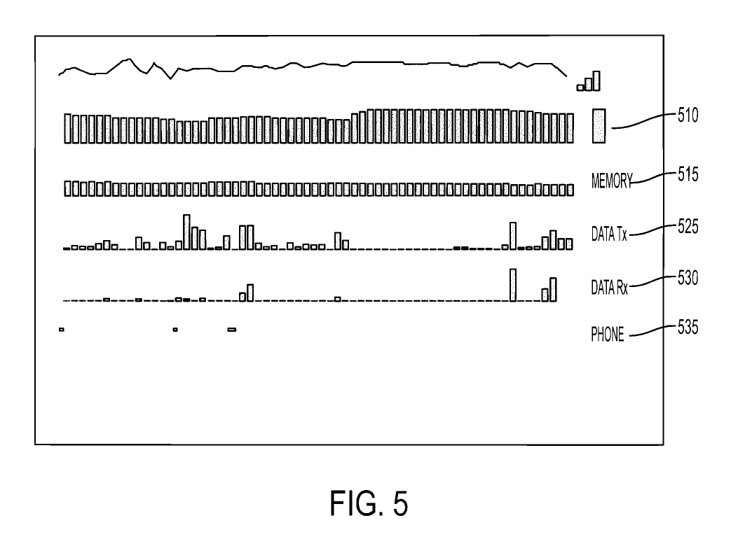

The stored data may be used to generate a report 391 that may be displayed or transmitted 392 to a remote support operation via a wired connection, the wireless communications network, or a near field communications system such as radio frequency transmission. The report 391 may include the identification of a trend over a period of time. For example, referring to FIG. 5, trends showing remaining battery life 510 may show trends such as an increase in the device's typical battery drain rate (which may indicate either a defective battery or that the user is using more power-intensive applications). Reports showing free memory usage over time 515 may show an increase in memory usage (which may indicate that device should be upgraded to include additional memory). Reports also may show levels of data transmitted 525 and/or received 530, as well as phone usage 535 over time. A trend may be identified from recorded information such as signal coverage, battery level, phone usage, and email traffic patterns over a period of time. The trend may include details about how long a particular error or issue has been occurring, or when a similar error or issue was last recorded. Optionally, the report may be or may include one or more of the screenshots that are taken of system operation.

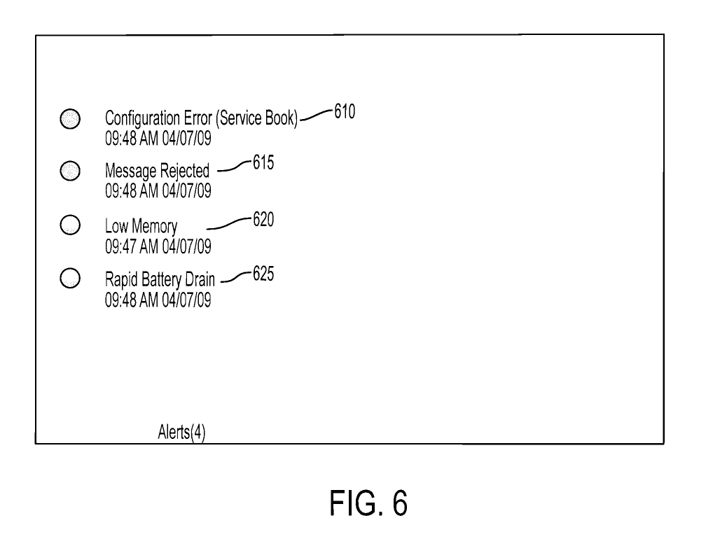

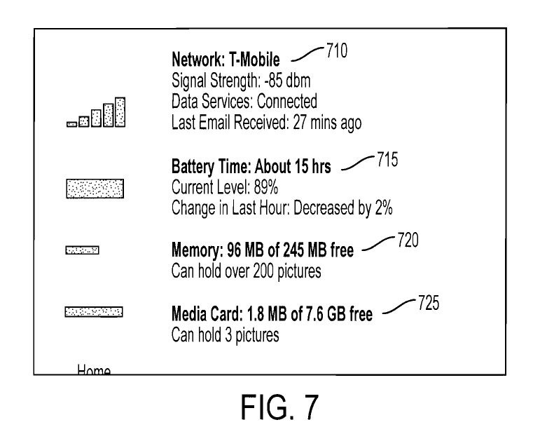

Optionally, the report may include data recorded over a time period and/or at particular times. For example, referring to FIG. 6, a report may show the time and/or duration of issues such as system configuration errors 610, messages that were rejected 615, low memory alerts 620, and/or times of rapid battery drain 625. Alternatively or in addition, the report may include currently-monitored parameters even if no alter exists. For example, FIG. 7 shows reports of communications network signal strength and usage 710; battery level and usage 715, memory used and available free memory 720, and optional other memory resource availability 725 such as that of a media card. The user or the application's settings may permit the time period to be selectively varied, such as 2 hours, 3 hours, 6 hours, 12 hours, 24 hours, or multiple days. When transmitted to a remote support operation, such as by email or via an automatic transmission, or in response to a request from the remote support operation, the remote support operation may use this data, correlate it with other data, and assess potential system-wide issues, or assess whether an individual communications device is operating outside of expected parameters as compared to other devices monitored by the support operation. The support operation may be a system administrator, information technology operation, phone service carrier, or other monitoring operation.

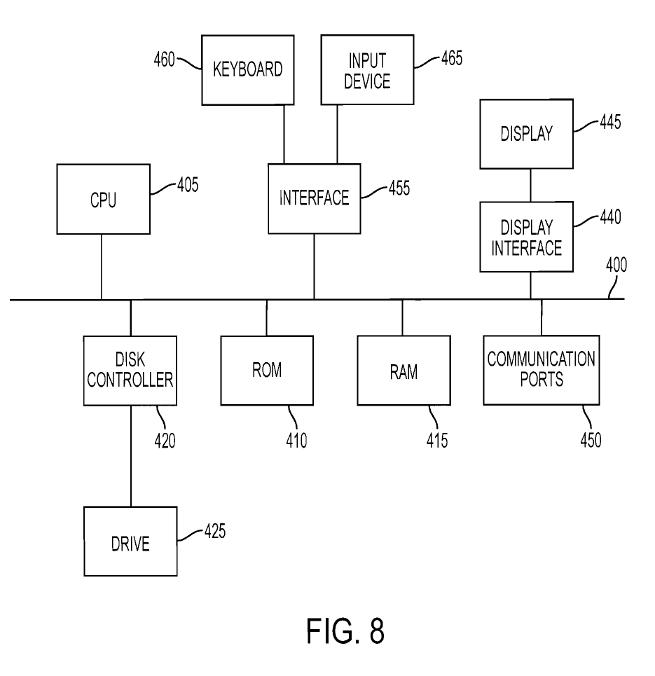

Portable communication devices contained herein may contain any or all of the elements of a portable computing device. The device may have an installed system monitoring module, which includes computer-readable instructions that instruct the device to perform any of the functions described above. FIG. 8 depicts a block diagram of an exemplary system that may be used to contain or implement program instructions according to an embodiment. Referring to FIG. 8, a bus 400 serves as the main information highway interconnecting the other illustrated components of the hardware. Central processing unit (CPU) 405 is the central processing device of the system, performing calculations and logic operations required to execute a program. Read only memory (ROM) 410 and random access memory (RAM) 415 constitute exemplary memory devices or storage media.

A disk controller 420 interfaces with one or more optional disk drives 425 to the system bus 400. These disk drives may include, for example, external or internal disk, flash memory, USB or other drives, or hard drives. As indicated previously, these various disk drives and disk controllers are optional devices.

Program instructions may be stored in the ROM 410 and/or the RAM 415. Optionally, program instructions may be stored on a computer readable storage medium, such as a hard drive, a compact disk, a digital disk, a memory or any other tangible recording medium.

An optional display interface 440 may permit information from the bus 400 to be displayed on the display 445 in audio, graphic or alphanumeric format. Communication with external devices may occur using various communication ports 450.

In addition to the standard computer-type components, the hardware may also include a data input interface 455 which allows for receipt of data from input devices such as a keyboard 460 or other input device 465 such as a pointing device, track wheel, remote control, or touch pad or touch-sensitive screen.

It appreciated that the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

What is claimed is:

1. A computer program product for monitoring the performance of a portable communications device, comprising:
a computer-readable medium containing instructions that cause a portable communications device to:
monitor at least one system configuration parameter associated with the device;
monitor at least one usage parameter associated with an operating system within the device;
monitor at least one operating parameter associated with a communications network that the device is using for communication; and
when any of the monitored parameters has a value indicative of a potential operational problem on the device:
display an alert on a display,
provide a user-selectable prompt that enables a user to receive resolution information on how to avoid the potential problem,
in response to a user selection of the prompt, display the resolution information, and
provide a user-selectable prompt that enables the user to implement a command on the device, wherein the command is associated with the resolution information.

2. The product of claim 1, wherein the instructions also comprise instructions that cause the device to monitor at least one parameter associated with an installed messaging application on the device.

3. The product of claim 1, further comprising:
instructions that cause the device to monitor at least one operating parameter associated with a messaging application that is installed in the device, and
wherein the potential operational problem comprises holding messages that take up more than a threshold amount of memory.

4. The product of claim 1, wherein:
the monitored operating parameter associated with the memory comprises an indicator of an amount of the memory that available free memory;
the potential operational problem comprises a low available free memory; and
the command comprises closing an application that is using the memory to run.

5. The product of claim 4, wherein the instructions also comprise instructions cause the device to:
monitor a battery drain rate for the device; and
if the monitored battery drain rate exceeds a threshold:
display a battery drain alert;
identify an application is running on the device and which requires a battery drain rate that exceeds that of at least one other application that is also running on the device, and
provide a user-selectable prompt that enables the user to close the identified application.

6. The product of claim 4, wherein the instructions also comprise instructions cause the device to:
monitor a battery drain rate for the device; and
if the monitored battery drain rate exceeds a threshold:
automatically implement an action on the device that will reduce the battery drain rate.

7. The product of claim 1, wherein the instructions also comprise instructions that cause the device to:
provide the user with a screen capture option that enables a user to:
record a snapshot of a display screen on the device, the display screen displaying the monitored parameters at the time of the snapshot;
save a snapshot file comprising data corresponding to the snapshot; and
transmit the snapshot file to a remote support operation via the communications network.

8. The product of claim 1, wherein the instructions also comprise instructions that cause the device to, from the device to a remote support operation:
automatically transmit each alert; and
for each alert, automatically transmit the monitored parameters at the time of the alert and an indication of applications that were in use on the device at the time that the alert was generated.

9. The product of claim 8, wherein the instructions also comprise instructions that cause the device to:
periodically cause the device to transmit to the remote support operation, during non-alert periods, an indication of applications that are in use on the device at the time; and
periodically cause the device to transmit to the remote support operation, during non-alert periods, the monitored parameters for the applications that are in use.

10. The product of claim 8, wherein the instructions also comprise instructions that cause the device to, in response to a request from the remote support operation, transmit:
an indication of applications that are in use on the device at the time; and
the monitored parameters for the applications that are in use.

11. The product of claim 8, wherein the instructions also comprise instructions that cause the device to:
store the alerts and monitored parameters over a period of time; and
after the period of time, correlate the alerts and monitored parameters to generate a report of at least one operational trend for the device over the period of time.

12. The product of claim 11, wherein the instructions also comprise instructions that cause the device to:
determine, from the stored alerts and monitored parameters, an expected operational condition over a period of time; and
analyzing the stored alerts and monitored parameters to determine whether the device is operating outside of an accepted deviation range from the expected operational condition.

13. The product of claim 12, wherein:
the expected operational condition comprises an expected amount of time that a communication application is typically in use when a device is roaming outside of a standard network area; and
the analyzing comprises determining whether the device is using a roaming service at a level that exceeds the expected amount of time by a threshold amount.

14. The product of claim 12, wherein:
the expected operational condition comprises an expected amount of time that a communication application encounters a loss of communications network coverage; and
the analyzing comprises determining whether the device has encountered a loss of communications network coverage at a level that exceeds the expected amount of time by a threshold amount, and if so identifying a communications network service provider for the communicating network and automatically transmitting an indication of the provider to a remote support operation.

15. The product of claim 11, wherein:
the operational trend comprises memory usage; and
if the trend indicates that memory usage has increased by a threshold amount over the period of time, then the resolution information comprises a suggestion to add additional memory to the device.

16. A method of monitoring the performance of a portable communications device, comprises:
monitoring, by a system monitoring module installed on a portable electronic device, at least one system configuration parameter associated with the device;
monitoring, by the module, at least one usage parameter associated with an operating system within the device;
monitoring, by the module, at least one operating parameter associated with a communications network that the device is using for communication; and
when any of the monitored parameters has a value indicative of a potential operational problem on the device:
displaying an alert on a display,
providing a user-selectable prompt that enables a user to receive resolution information on how to avoid the potential problem,
receiving a user selection corresponding to the resolution information;
in response to the user selection, displaying the resolution information; and
providing a user-selectable prompt that enables the user to implement a command on the device, wherein the command is associated with the resolution information.

17. The method of claim 16, wherein:
the monitored operating parameter associated with the memory comprises an indicator of an amount of the memory that available free memory;
the potential operational problem comprises a low available free memory; and
the command comprises closing an application that is using the memory to run.

18. The method of claim 16, further comprising:
monitoring, by the module, a battery drain rate for the device; and
when the monitored battery drain rate exceeds a threshold:
displaying a battery drain alert; and
closing an application is running on the device and which requires a battery drain rate that exceeds that of at least one other application that is also running on the device.

19. The method of claim 16, further comprising, by the module:
recording a snapshot of a display screen on the device, the display screen displaying the monitored parameters at the time of the snapshot;
saving a snapshot file comprising data corresponding to the snapshot; and
transmitting the snapshot file to a remote support operation via the communications network.

20. The method of claim 16, further comprising:
transmitting alerts generated by the module to a remote support operation;
for each alert, automatically transmitting the monitored parameters at the time of the alert and an indication of applications that were in use on the device at the time that the alert was generated; and
periodically transmitting to the remote support operation, during non-alert periods, an indication of applications that are in use and monitored parameters on the device at the time of the periodic transmission.
